(19) United States
(12) Patent Application Publication
(10) Pub. No.: US 2008/0202778 A1
(43) Pub. Date: Aug. 28, 2008

(54) TOOL

(76) Inventor: Gregory Dennis Cahill, South Albury (AU)

Correspondence Address: KNOBBE MARTENS OLSON & BEAR LLP, 2040 MAIN STREET, FOURTEENTH FLOOR, IRVINE, CA, 92614, US

(21) Appl. No.: 11/760,576

(22) Filed: Jun. 8, 2007

(30) Foreign Application Priority Data
Feb. 26, 2007 (AU) 2007900948

(51) Int. Cl. A01B 15/02

(52) U.S. Cl. 172/71; 172/272

(57) ABSTRACT

A tool for fixing to a vehicle, wherein the tool is movable between a deployed condition in which a working element of the tool is positioned for acting upon a ground surface, and a stowed condition in which the working element is raised to be spaced from the ground surface. In one form, the tool is in the form of a plough unit, and the vehicle is a loader with ground-engaging tracks for effecting movement of the loader relative to the ground surface.

### BACKGROUND OF THE INVENTION

1. Field of the Invention

This invention relates to a tool for acting upon a ground surface and, more particularly but not exclusively, to a stowable vehicle-mounted ripper plough.

2. Description of the Related Art

It is known to provide a vehicle for moving earth and such like, for example in the form of a loader vehicle. In particular, it is known to provide a loader vehicle having a bucket at a front end for transporting earth material and a pair of endless tracks for effecting movement of the loader on a ground surface. One such kind of loader is produced under the trademark “Posi-track” by ASV Inc., and a particular family of the Posi-track kind of loaders is known as the “R-series”. The applicant has determined that the present invention is particularly suited to a model of the R-series family, known as the RC-60 which is not provided with a plough.

The applicant has determined it would be advantageous to add functionality to loaders of the RC-60 type by providing a plough unit tool for fixing to the loader to enable the loader to be used for ploughing a ground surface. Examples of the present invention seek to provide this advantage.

### SUMMARY OF THE INVENTION

In accordance with the present invention, there is provided a scarifying tool for fitting to a vehicle, wherein the tool has a brace assembly for attaching to a body of the vehicle, the tool is movable between a deployed condition in which a working element of the tool is positioned for acting upon a ground surface and a stowed condition in which the working element is raised to be spaced from the ground surface, and wherein the brace assembly is arranged to retract upwardly to either side of the vehicle body when in the stowed condition so as to bring the working element into a stowed position in proximity with a rear of the body.

Preferably, the brace assembly is mounted to locations at either side of the vehicle body.

Preferably, the brace assembly is arranged such that the vehicle has substantially the same angular ground clearance with the tool in the stowed condition as with the tool removed from the vehicle.

Preferably, the brace assembly is arranged such that the vehicle has substantially the same centre of gravity with the tool in the stowed condition as with the tool removed from the vehicle.

Preferably, the tool is adapted for retrofitting to an existing vehicle.

Preferably, the brace assembly is pivoted through a horizontal configuration in moving between the stowed and deployed conditions.

Preferably, the tool is a plough unit.

Preferably, when in the deployed condition the tool is positioned for acting upon the ground surface behind the vehicle. Even more preferably, when in the stowed condition only driving tracks of the vehicle engage the ground surface.

Preferably, the plough unit has a plurality of working elements in the form of plough elements.

Preferably, the tool includes a pair of mountings for fixing to either side of a body of the vehicle, a pair of arms coupled to the mountings, and a cross member mounted between the arms. A plurality of working elements in the form of plough elements may be attached to the cross member. More preferably, each of the arms is pivotably coupled at one end to a respective one of the mountings, and is pivotably coupled at an opposite end to the cross member. Pivotable coupling in this way facilitates movement of the tool between the deployed condition and the stowed condition.

Even more preferably, each of the arms includes a first arm component pivotably coupled between the respective mounting and the cross member, and a second arm component also pivotably coupled between the respective mounting and the cross member, wherein the second arm component is generally parallel to the first arm component so as to maintain correct orientation of the cross member about its own axis.

Preferably, the tool includes a hydraulic cylinder for controlling movement of the plough unit between the deployed configuration and the stowed configuration. More preferably, the tool includes a pair of hydraulic cylinders, each hydraulic cylinder being coupled between one of the mountings and the respective arm. Even more preferably, the hydraulic cylinders are adapted for connection to an existing hydraulic system of the vehicle.

In accordance with another aspect of the present invention, there is provided a vehicle fitted with a tool as described above.

Preferably, the vehicle is a loader. Even more preferably, the loader has ground engaging tracks for effecting movement of the loader relative to the ground surface.

In accordance with yet another aspect of the present invention, there is provided a method of fitting a tool to a vehicle, including the steps of: installing a multiple port diverter in an existing hydraulic system of the vehicle, connecting a pair of input ports of the diverter to a control valve of the hydraulic system,

connecting a first pair of output ports of the diverter to an existing hydraulic device of the vehicle, and

connecting a second pair of output ports of the diverter to the tool.

### BRIEF DESCRIPTION OF THE DRAWINGS

The invention is described, by way of non-limiting example only, with reference to the accompanying drawings in which:

FIG. 1 is a perspective view of a tool in the form of a plough unit in accordance with an example;

FIG. 2 is a perspective view of a tool in the form of a plough unit similar to the one shown in FIG. 1;

FIG. 3 is a rear view of the plough unit shown in FIG. 2;

FIG. 4 is a side view of the plough unit shown in FIGS. 2 and 3;

FIG. 5 is a side view of a loader fitted with a plough unit similar to the plough units shown in FIGS. 1 to 4, with the plough unit shown in a deployed condition;

FIG. 6 is a top view of the loader of FIG. 5, shown with the plough unit in the deployed condition,

FIG. 7 is a side view of the loader of FIGS. 5 and 6, shown with the plough unit in a stowed condition,

FIG. 8 is a top view of the loader of FIGS. 5 to 7, shown with the plough unit in the stowed condition,

FIG. 9 is a rear perspective view of the loader of FIGS. 5 to 8, with the plough unit shown in the stowed condition,

FIG. 10 is a detailed view of the rear of the loader of FIGS. 5 to 9, with the plough unit shown in the stowed condition,

FIG. 11 shows a multiple port diverter, and

FIG. 12 is a diagram of a modified hydraulic system of a loader fitted with a plough unit.

### DETAILED DESCRIPTION OF THE INVENTION

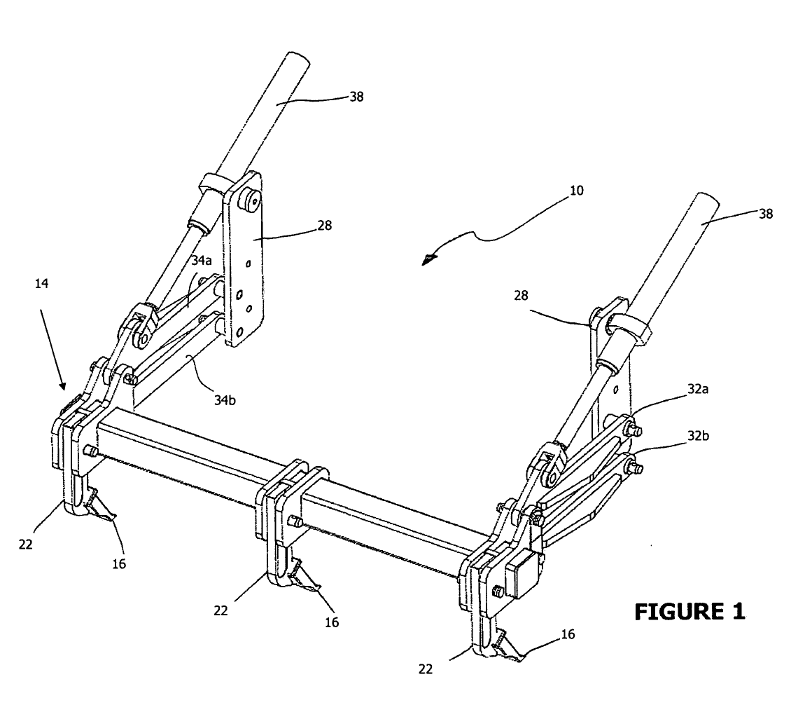

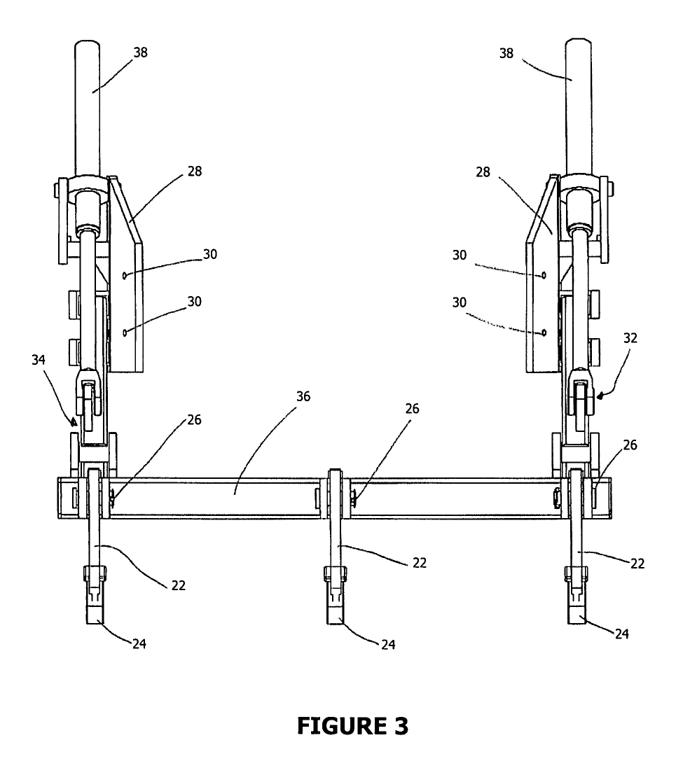

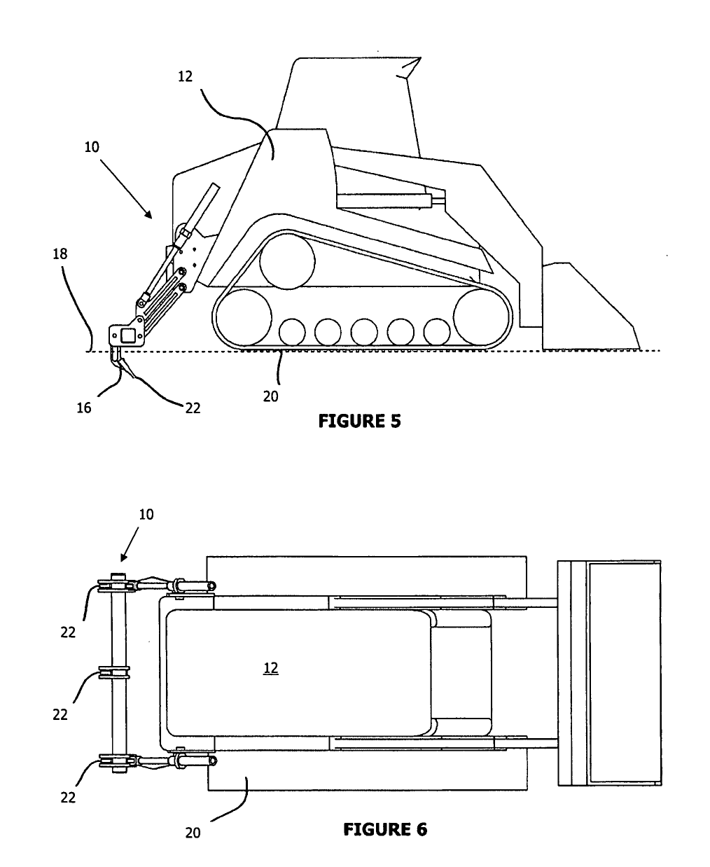

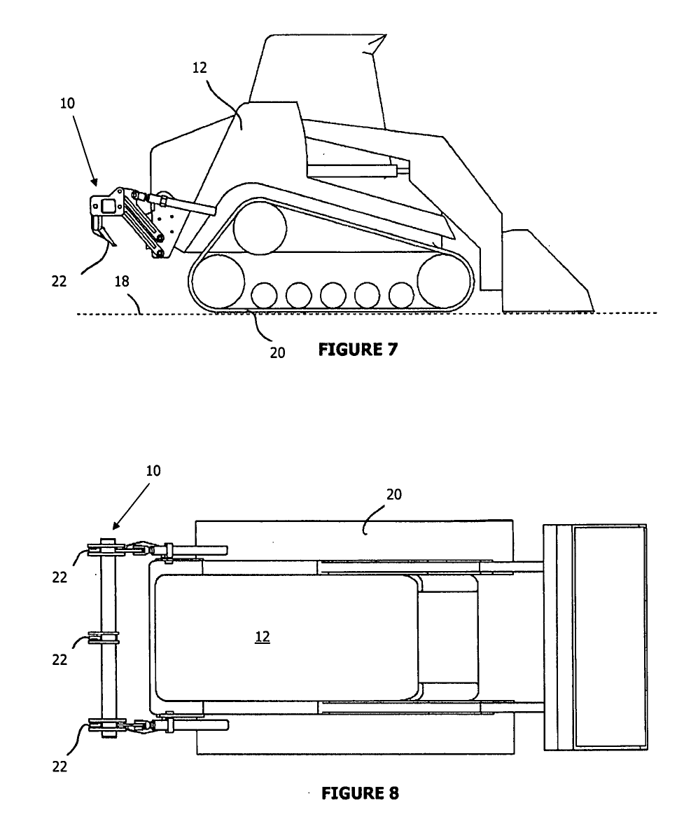

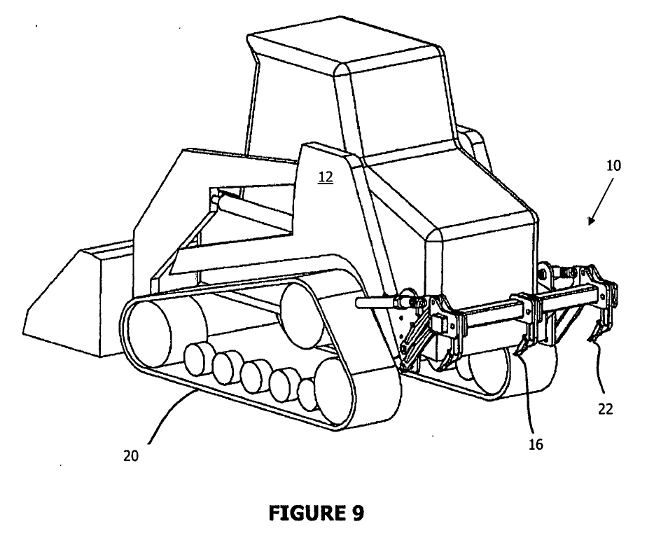

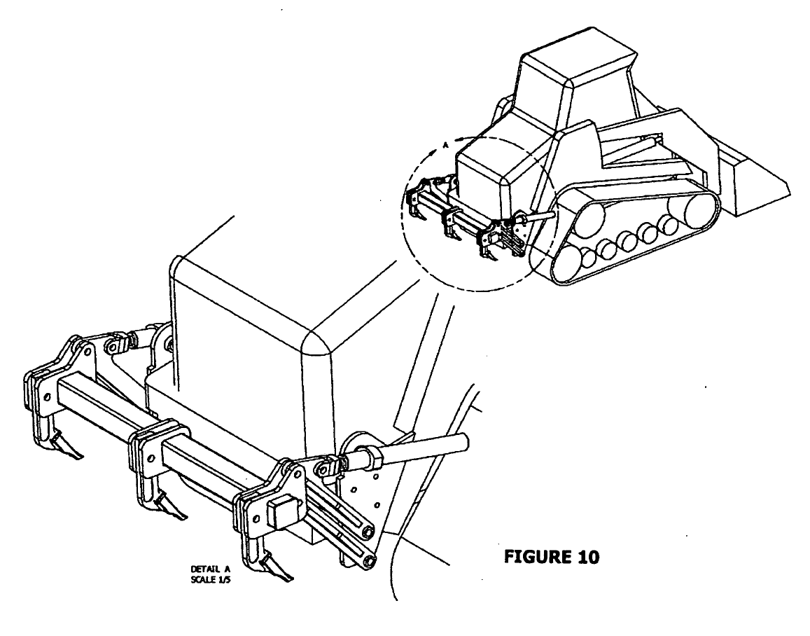

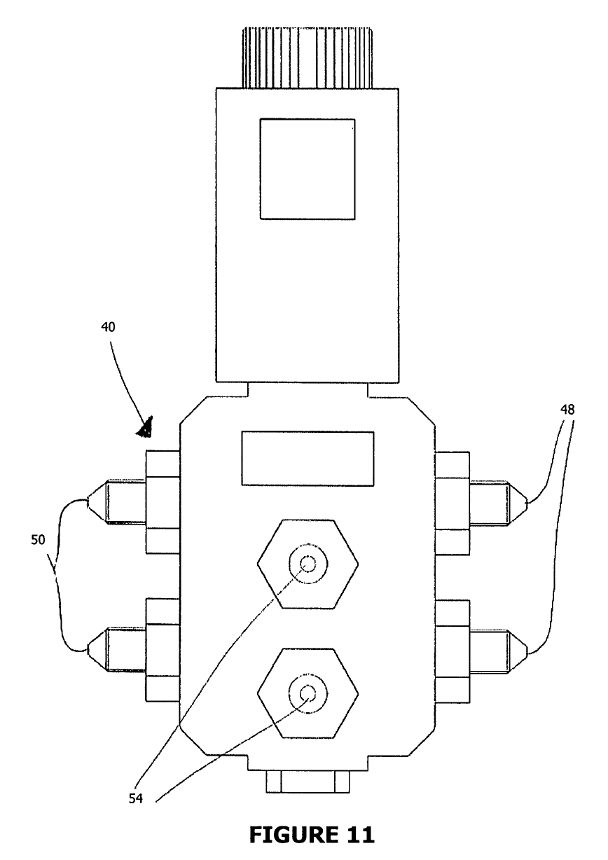

With reference to FIGS. 1 to 10, there is shown a scarifying tool 10 for retrofitting to a vehicle 12. The tool 10 is in the form of a plough unit 14, and is movable between a deployed condition (as shown in FIGS. 5 and 6) in which a working element 16 of the tool 10 is positioned for acting upon a ground surface 18, and a stowed condition (as shown in FIGS. 7 to 10) in which the working element 16 is raised to be spaced from the ground surface 18.

The tool 10 has a brace assembly for attaching to a body of the vehicle 12, and the brace assembly is pivoted through a horizontal configuration in moving between the stowed and deployed conditions. In the horizontal configuration, arms 32 and 34 of the brace assembly extend horizontally rearward from mounting plates 28 which are fixed to either side of the vehicle body. Advantageously, as the deployed configuration is below the horizontal configuration, and the stowed configuration is above the horizontal configuration, the working element 16 is kept in a compact arrangement where it is relatively close to the vehicle 12 in a forward/rearward sense in both deployed and stowed configurations. The brace assembly is arranged to retract upwardly to either side of the vehicle body when in the stowed condition so as to bring the working element 16 upward into a stowed position in close proximity with a rear of the body of the vehicle 12, as shown in FIGS. 7 to 10

Advantageously, as the working element 16 is brought into close proximity with the rear of the body of the vehicle when in the stowed condition, this allows substantially the same angular ground clearance and centre of gravity to be maintained with the tool 10 in the stowed condition as with the tool removed from the vehicle.

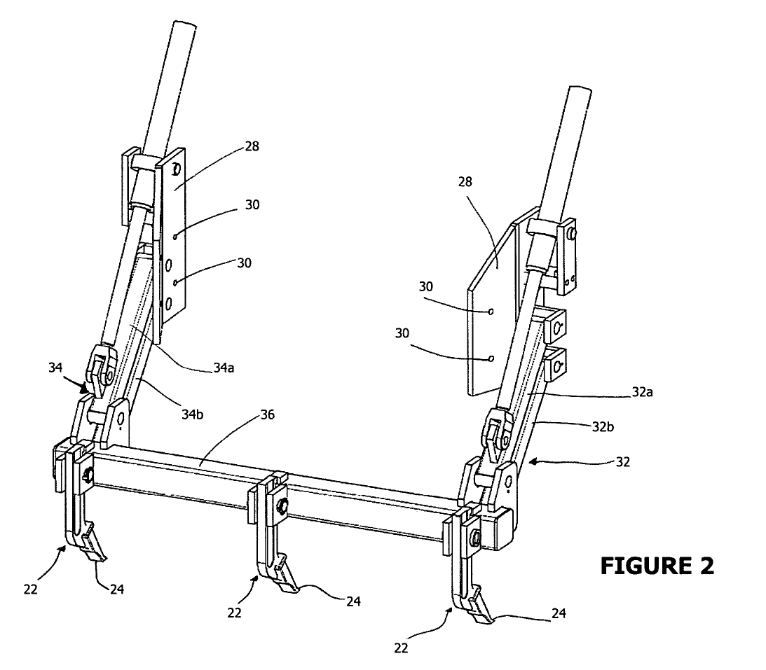

FIGS. 2 to 4 show the plough unit 14 in the deployed condition, and

FIG. 1 shows the plough unit 14 in a configuration intermediate the deployed and stowed conditions.

As depicted in FIGS. 5 and 6, when in the deployed condition the plough unit 14 is positioned for acting upon the ground surface 18 behind the vehicle 12. By virtue of the plough unit 14 being fixed directly to the vehicle 12, the plough unit 14 is fully supported by the vehicle 12 and no additional wheels or other supports are required, as is the case in some previously proposed trailer ploughs. Accordingly, when the plough unit 14 is in the stowed condition, only driving tracks 20 of the vehicle 12, and possibly also a front bucket of the vehicle, engage the ground surface 18.

The plough units 14 of the examples shown have three working elements 16 in the form of plough elements 22 which are configured with blades 24 suitable for ripping the ground surface 18 as the vehicle 12 travels in a forward direction. The plough elements 22 may be adapted to be pivoted about pins 26 such that the plough elements 22 are able to retract automatically when the vehicle 12 is driven in a rearward direction.

The plough unit 14 includes a pair of mounting plates 28 for fixing to locations at either side of a body of the vehicle 12 by way of bolts which may be anchored through holes 30 formed in the mounting plates 28. Arms 32, 34 are pivotably coupled to the mounting plates 28, and a cross member 36 is mounted between the arms 32, 34. The plough elements 22 are attached to the cross member 36 by way of the pins 26.

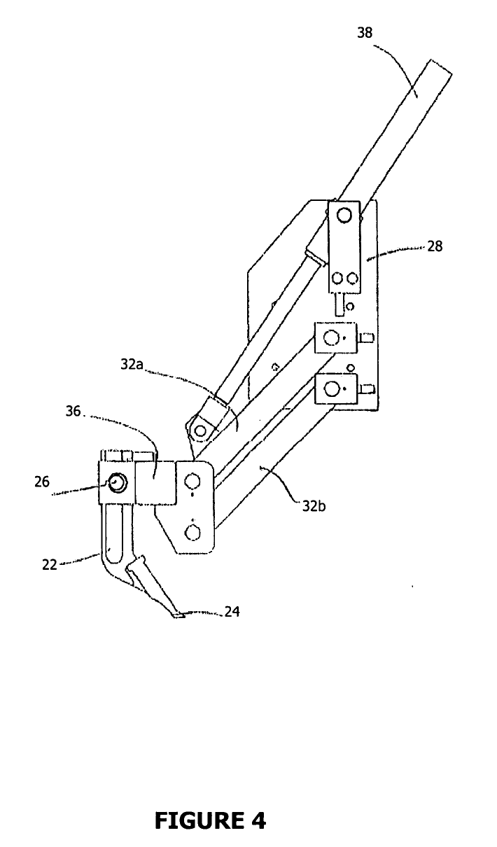

Each of the arms 32, 34 is pivotably coupled at one end to a respective one of the mounting plates 28, and is pivotably coupled at an opposite end to the cross member 36 to facilitate movement of the plough unit 14 between the deployed condition and the stowed condition. The arms 32, 34 each include a first arm component 32a, 34a pivotably coupled between the respective mounting plate 28 and the cross member 36, and a second arm component 32b, 34b also pivotably coupled between the respective mounting plate 28 and the cross member 36. As can be seen most clearly in the side view of FIG. 4, the second arm component 32b is generally parallel to the first arm component 32a so as to maintain correct orientation of the cross member 36 (and thus also the plough elements 22) about the axis of the cross member 36 in both deployed and stowed conditions.

The plough unit 14 includes a pair of hydraulic members 38 for controlling movement of the plough unit 14 between the deployed configuration and the stowed configuration, each hydraulic member 38 being pivotably coupled between one of the mounting plates 28 and the respective arm 32, 34. The hydraulic members 38 may be pivotally coupled to the mounting plates 28 by one-sided trunnions as shown in FIG. 1, or two-sided trunnions as shown in FIG. 2, however it is preferred that one-sided trunnions are used as they provide a more compact and simpler arrangement.

The hydraulic members 38 are adapted for connection to an existing hydraulic system of the vehicle 12 such that a separate power supply is not required. As such, the plough unit 14 is virtually a simple “bolt on” modification to an existing vehicle, particularly in cases where the vehicle already has a spare hydraulic line to which the hydraulic members 38 can be connected.

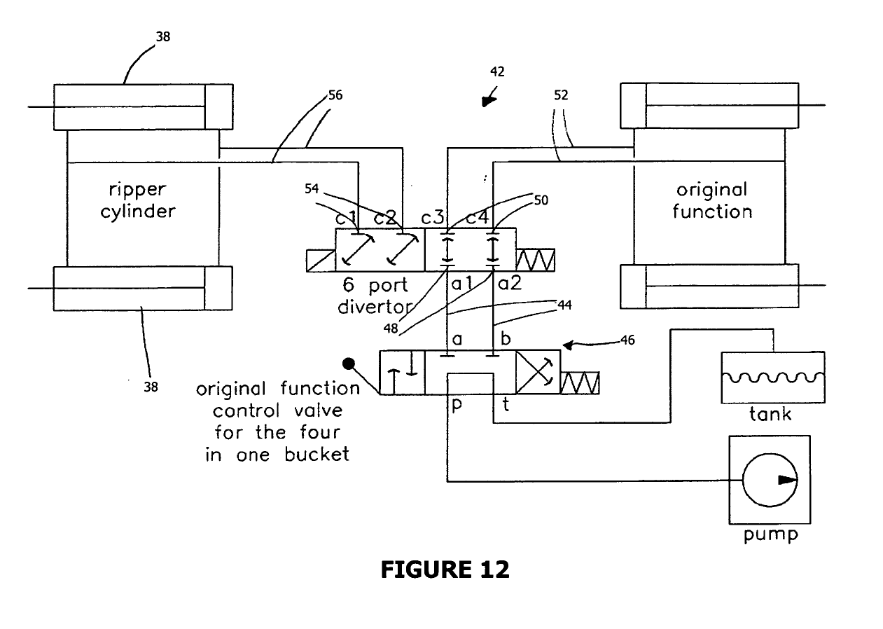

An existing hydraulic system of a loader not originally having a plough unit 14 can be modified to allow fitment of a plough unit 14 by installing a multiple port diverter 40, for example a 6 port diverter as shown in FIGS. 11 and 12. With reference to FIG. 12 in particular, a hydraulic system 42 with only a single pair of hydraulic lines 44, a feed line and a return line, for controlling a four-in-one bucket of the loader by a control valve 46, may be modified to accommodate hydraulics of the plough unit 14 by connecting the single pair of hydraulic lines 44 to input ports 48 of the diverter 40, by connecting a first pair of output ports 50 of the diverter 40 to existing hydraulic lines 52 of the bucket, and by connecting a second pair of output ports 54 of the diverter 40 to hydraulic lines 56 of the plough tool 14. In this way, the hydraulic members 38, and thus the plough tool 14, are able to be controlled by the hydraulic system 42.

Although the vehicle depicted in FIGS. 5 to 10 of the accompanying drawings is based on an RC-60 “Posi-track” type loader, it will be appreciated by those skilled in the art that other examples of the invention may be used with other vehicles. Also, those skilled in the art will appreciate that a tool in accordance with the present invention may be retro-fitted to an existing vehicle, or may be provided as standard or optional equipment on a new vehicle.

Advantageously, the tool 10 enables existing vehicles such as the RC-60 “Posi-track” loader to be adapted for use in ploughing (or “ripping”) a ground surface. It is beneficial that the tool 10 trails the vehicle 12 such that it is dragged through the ground surface 18 as this provides greater stability and fewer snags than in previously proposed vehicles which have a forked bucket at a front end of the vehicle for agitating a ground surface. The tool 10 provides a simple, affordable and effective way to increase the utility of existing machinery.

The above tool has been described by way of example only and modifications are possible within the scope of the invention. For example, although the tool has been described in the example above as being in the form of a plough unit, in other examples the tool may take other forms such as, for example, a sowing tool.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

What is claimed is:

1. A scarifying tool for fitting to a vehicle, wherein the tool has a brace assembly for attaching to a body of the vehicle, the tool is movable between a deployed condition in which a working element of the tool is positioned for acting upon a ground surface and a stowed condition in which the working element is raised to be spaced from the ground surface, and wherein the brace assembly is arranged to retract upwardly to either side of the vehicle body when in the stowed condition so as to bring the working element into a stowed position in proximity with a rear of the body.

2. A scarifying tool as claimed in claim 1, wherein the brace assembly is mounted to locations at either side of the vehicle body.

3. A scarifying tool as claimed in claim 1, wherein the brace assembly is arranged such that the vehicle has substantially the same angular ground clearance with the tool in the stowed condition as with the tool removed from the vehicle.

4. A scarifying tool as claimed in claim 1, wherein the brace assembly is arranged such that the vehicle has substantially the same centre of gravity with the tool in the stowed condition as with the tool removed from the vehicle.

5. A scarifying tool as claimed in claim 1, wherein the tool is adapted for retro-fitting to an existing vehicle.

6. A scarifying tool as claimed in claim 1, wherein the brace assembly is pivoted through a horizontal configuration in moving between the stowed and deployed conditions.

7. A tool as claimed in claim 1, wherein the tool is in the form of a plough unit.

8. A tool as claimed in claim 7, wherein, when in the deployed condition, the plough unit is positioned for engaging the ground surface behind the vehicle.

9. A tool as claimed in claim 7, wherein, when in the stowed condition, only driving tracks of the vehicle engage the ground.

10. A tool as claimed in claim 7, wherein the plough unit includes a pair of mountings for fixing relative to either side of a body of the vehicle, a pair of arms coupled to the mountings, and a cross member mounted between the arms.

11. A tool as claimed in claim 10, wherein a plurality of working elements in the form of plough elements are attached to the cross member.

12. A tool as claimed in claim 10, wherein each of the arms is pivotably coupled at one end to a respective one of the mountings, and is pivotably coupled at an opposite end to the cross member.

13. A vehicle fitted with a tool as claimed in any one of claims 1 to 12, wherein the vehicle is a loader with ground-engaging tracks for effecting movement of the loader relative to the ground surface.

14. A method of fitting a tool to a vehicle, including the steps of:
installing a multiple port diverter in an existing hydraulic system of the vehicle,
connecting a pair of input ports of the diverter to a control valve of the hydraulic system,
connecting a first pair of output ports of the diverter to an existing hydraulic device of the vehicle, and
connecting a second pair of output ports of the diverter to the tool.
